(19) United States
(12) Patent Application Publication
(10) Pub. No.: US 2026/0328662 A1
(43) Pub. Date: Oct. 22, 2026

(54) SINGLE-PARTICLE FULL-COVERAGE LOADING DEVICE

(71) Applicant: Guangdong University of Technology, Guangzhou (CN)

(72) Inventors: Wanying WANG, Guangzhou (CN); Yaming ZHOU, Guangzhou (CN); Qingzi LUO, Guangzhou (CN)

(73) Assignee: Guangdong University of Technology, Guangzhou (CN)

(21) Appl. No.: 19/390,721

(22) Filed: Nov. 17, 2025

Related U.S. Application Data
(63) Continuation of application No. PCT/CN2025/131073, filed on Oct. 30, 2025.

(30) Foreign Application Priority Data
Apr. 17, 2025 (CN) 2025104800381

(51) Int. Cl. G01N 3/02

(52) U.S. Cl. CPC G01N 3/02; G01N 2203/0284; G01N 2203/04

(57) ABSTRACT

The present disclosure discloses a single-particle full-coverage loading device, and relates to the technical field of geotechnical engineering experimental equipment. The present disclosure comprises a uniaxial loading head, a clamping plate, a bearing platform, a full-coverage loading head, and a sensor group, wherein one side of a top of the clamping plate is provided with a first mounting hole, and the other side of the top of the clamping plate is provided with a second mounting hole. The present disclosure measures mechanical properties of a single-particle model under a full-coverage complex stress state by loading different loads. The single-particle full-coverage loading device is based on a three-dimensional needle carving structure, which expands the loading modes for single particles. The device is capable of realizing multi-point full-coverage loading of single particles through a single-particle full-coverage loading head, thereby observing the mechanical behaviors of the single particles.

### CROSS-REFERENCE TO RELATED APPLICATIONS

The application claims priority to Chinese patent application No. 2025104800381, filed on Apr. 17, 2025, the entire contents of which are incorporated herein by reference.

### TECHNICAL FIELD

The present disclosure belongs to the technical field of geotechnical engineering experimental equipment, and particularly relates to a single-particle full-coverage loading device.

### BACKGROUND

As a typical structural soil material, natural cemented sand is widely used in practical engineering. At present, most researches on the mechanical behavior of the cemented sand remain at a macroscopic level, lack understanding of its internal particle interaction mechanism, has unclarity in the connection between the crushing behavior of the cemented sand and the macroscopic mechanical response at a particle scale. This essentially limits the comprehensive understanding of the cemented sand and other structural soil bodies. Only by deeply grasping the internal structure evolution law and damage mechanism of the cemented sand from phenomenon to essence and from macro to micro, prevention and control measures that fundamentally deal with related disasters in practical engineering can be proposed. Therefore, conducting researches on the fragmentation mode and microscopic damage mechanism of cemented sand particles, and grasping the true mechanical properties of microscopic cemented sand particles are of great theoretical value and practical significance for further improving the multi-scale mechanical mechanism research of structural soil and even for geotechnical engineering construction.

Experimental results obtained by different loading modes for single particles are completely different. If different loading modes, including single-point loading or planar loading, are adopted for the single particles, the single particles are caused to exhibit different mechanical behaviors. The research on single-particle full-coverage loading is of great significance. However, the existing single-particle loading device cannot be applied to multiple types of particles and has a single loading mode, thereby resulting in a reduction in the overall practicality of the device.

Thus, a single-particle full-coverage loading device is provided to solve the above problems.

### SUMMARY

The purpose of the present invention is to provide a single-particle full-coverage loading device. Through the cooperation between a uniaxial loading head and a full-coverage loading head, the problems that the single-particle loading device in the prior art cannot be applied to multiple types of particles and has a single loading mode for single particles are solved.

To solve the above technical problems, the present disclosure is achieved through the following technical solution:

The present disclosure provides a single-particle full-coverage loading device, comprising a uniaxial loading head, a clamping plate, a bearing platform, a full-coverage loading head, and a sensor group, wherein one side of a top of the clamping plate is provided with a first mounting hole, and the other side of the top of the clamping plate is provided with a second mounting hole; and the full-coverage loading head further comprises a shell, a retainer disposed in an inner cavity of the shell, needle chambers disposed in the inner cavity of the shell, needle bodies disposed in inner cavities of the needle chambers, spiral support rods fixedly connected to one end of the needle bodies, springs fixedly connected to one end of the spiral support rods, anti-shake column slits provided at inner walls on both sides of the needle chambers, anti-shake columns disposed in inner cavities of the anti-shake column slits, needle heads fixedly connected to one end of the anti-shake columns, and a retaining slit provided at a lower part of the shell.

The present disclosure is further configured as follows: the other ends of the springs are fixedly connected to a bottom of the inner cavity of each needle chamber, and the uniaxial loading head is disposed in an inner cavity of the second mounting hole.

The present disclosure is further configured as follows: one side of the clamping plate is provided with a first cutting slit, and the other side of the clamping plate is provided with a second cutting slit.

The present disclosure is further configured as follows: one side of a front surface of the clamping plate is provided with a first fixing hole, and the other side of the front surface of the clamping plate is provided with a second fixing hole.

The present disclosure is further configured as follows: one end of the retainer is provided with a push-pull handle, and a surface of the retainer is provided with triangular beams.

The present disclosure has the following beneficial effects.
1. In the present disclosure, through the disposal of the retainer and the push-pull handle, on the basis of a three-dimensional needle carving structure, in the process of an experiment, an experimenter may push the push-pull handle so that the retainer enters the retaining slit in the inner cavity of the shell, so that the triangular beams and the spiral support rods are stably engaged. This engagement relationship is similar to the engagement between a screw and a nut. In a shaping stage, the needle bodies undergo different degrees of displacement due to the surface shape of single particles. In a subsequent loading stage, the retainer is inserted into the retainer slit in the inner cavity of the shell and used for fixing the needle bodies at any positions through the engagement relationship between the triangular beams and the spiral support rods. The fixed needle bodies cannot return to original positions, which ensures that the loading needle heads fully cover the single particles and can adapt to various single particles of different shapes.
2. In the present disclosure, through the design of the cutting slits reserved in the clamping plate, a mounting process of a linear displacement sensor group is simplified. The tightness of screws needs to be controlled only to adjust disassembly and fixation. This not only prevents damage to the linear displacement sensor group due to too tight tightening, but also avoids experimental errors caused by the shake of the linear displacement sensor group during a test due to the failure to completely fix the linear displacement sensor group.
3. In the present disclosure, full-coverage loading may be performed on natural quartz sand and other single particle materials, and can be well adapted to the single particles of various shapes. The destructive behavior and the mechanical shape of the single particles under full-coverage loading are researched. Moreover, one loading device may realize full-coverage loading modes at the same time, and is widely applicable to the single particles of various shapes.

Of course, any product that implements the present disclosure does not necessarily achieve all of the above advantages at the same time.

### BRIEF DESCRIPTION OF DRAWINGS

To more clearly describe the technical solutions in the implementations of the present disclosure, the drawings required to be used in the description of the implementations will be simply presented below.

FIG. 1 is a three-dimensional diagram of a single-particle full-coverage loading device.

FIG. 2 is a front view of a full-coverage loading head in a single-particle full-coverage loading device.

FIG. 3 is a top view of a full-coverage loading head in a single-particle full-coverage loading device.

FIG. 4 is a side view of a full-coverage loading head in a single-particle full-coverage loading device.

FIG. 5 is a schematic diagram of an engagement structure of a retainer and a spiral support rod in a single-particle full-coverage loading device.

FIG. 6 is a front view of a needle body in a single-particle full-coverage loading device.

FIG. 7 is a top view of a needle body in a single-particle full-coverage loading device.

FIG. 8 is a schematic diagram of a clamping plate in a single-particle full-coverage loading device.

In the figures: 1. uniaxial loading head; 2. clamping plate; 3. full-coverage loading head; 4. bearing platform; 5. sensor group; 6. shell; 7. retainer; 8. needle body; 9. needle chamber; 10. anti-shake column slit; 11. needle head; 12. anti-shake column; 13. spiral support rod; 14. spring; 15. triangular beam; 16. first mounting hole; 17. second mounting hole; 18. first cutting slit; 19. second cutting slit; 20. first fixing hole; 21. second fixing hole; 22. push-pull handle.

### DETAILED DESCRIPTION OF THE EMBODIMENTS

The technical solutions in the implementations of the present disclosure will be described below in conjunction with the drawings in the implementations of the present disclosure. The described implementations are merely part of the implementations of the present disclosure, not all of the implementations.

### Implementation 1

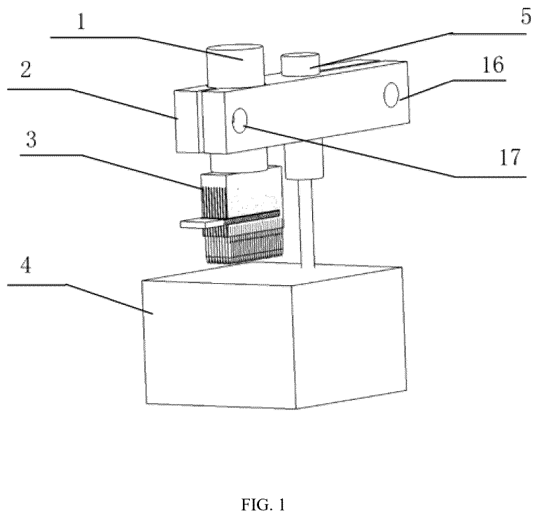

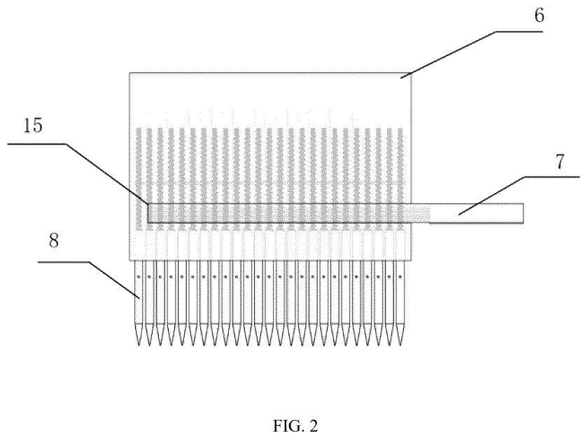

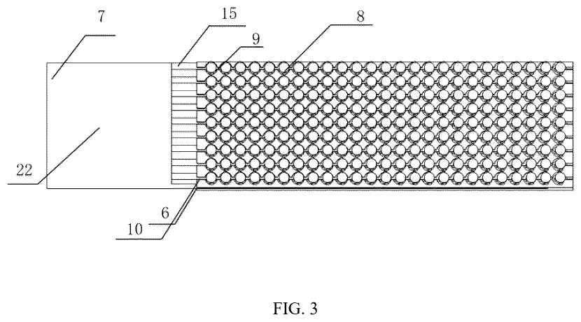

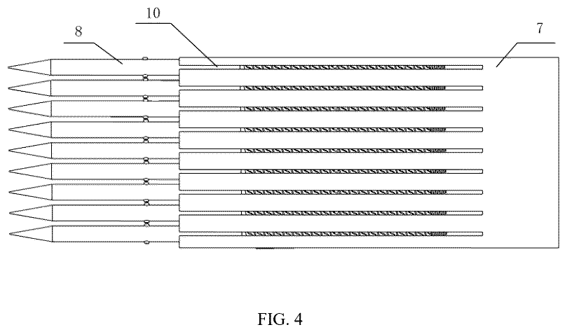

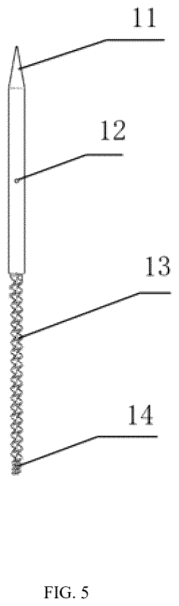

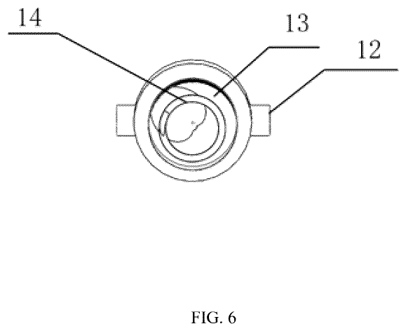

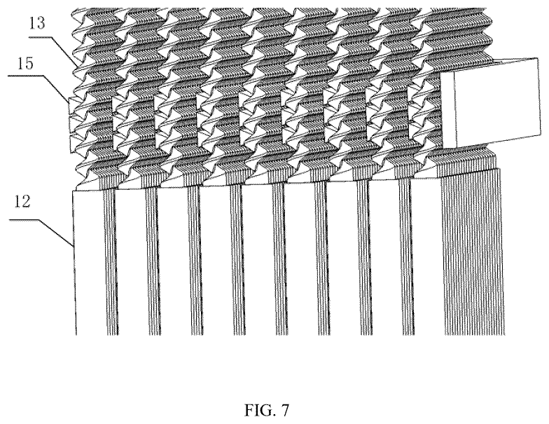

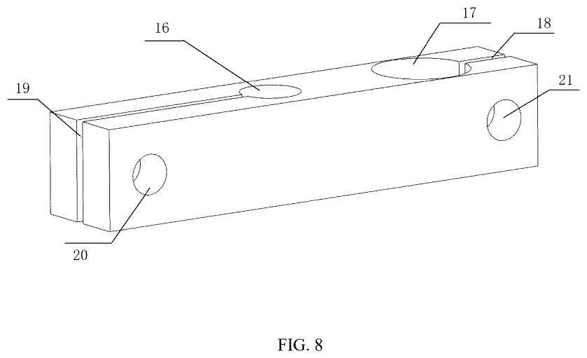

By referring to FIG. 1 to FIG. 8, the present disclosure provides a single-particle full-coverage loading device, comprising a uniaxial loading head 1, a clamping plate 2, a bearing platform 4, a full-coverage loading head 3, and a sensor group 5; one side of a top of the clamping plate 2 is provided with a first mounting hole 16, and the other side of the top of the clamping plate 2 is provided with a second mounting hole 17; and the full-coverage loading head 3 further comprises a shell 6, a retainer 7 disposed in an inner cavity of the shell 6, needle chambers 9 disposed in the inner cavity of the shell 6, needle bodies 8 disposed in inner cavities of the needle chambers 9, spiral support rods 13 fixedly connected to one end of the needle bodies 8, springs 14 fixedly connected to one end of the spiral support rods 13, anti-shake column slits 10 provided at inner walls on both sides of the needle chambers 9, anti-shake columns 12 disposed in inner cavities of the anti-shake column slits 10, needle heads 11 fixedly connected to one end of the anti-shake columns 12, and a retaining slit provided at a lower part of the shell 6.

Further supplementation: the needle chambers 9 are uniformly arranged in a mesh in the inner cavity of the shell 6, and are arranged in twenty-five rows and nine columns. A width of the retaining slit is greater than a thickness of the retainer 7 which may be correspondingly inserted. The surface of the retainer 7 is provided with the triangular beams 15 which are uniformly arranged in nine rows and three columns. Through the engagement relationship between the triangular beams 15 and the spiral support rods 13, the needle bodies 8 may be molded by single particles and then positioned by inserting the retainer 7. At the same time, the needle bodies 8 may be fixed at any heights, which provides a stable bearing capacity for a loading stage after a molding stage.

### Implementation 2

By referring to FIG. 1 to FIG. 8, on the basis of implementation 1, the other ends of the springs 14 are fixedly connected to a bottom of the inner cavity of each needle chamber 9, and the uniaxial loading head 1 is disposed in an inner cavity of the second mounting hole 17; one side of the clamping plate 2 is provided with a first cutting slit 18, and the other side of the clamping plate 2 is provided with a second cutting slit 19; the first cutting slit 18 and the second cutting slit 19 extend from an edge of one side of the clamping plate 2 to the second mounting hole 17 and the first mounting hole 16 respectively; one side of a front surface of the clamping plate 2 is provided with a first fixing hole 20, and the other side of the front surface of the clamping plate 2 is provided with a second fixing hole 21; axes of the first fixing hole 20 and the second fixing hole 21 are perpendicular to and penetrate the second cutting slit 19 and the first cutting slit 18 respectively; one end of the retainer 7 is provided with a push-pull handle 22, and a surface of the retainer 7 is provided with triangular beams 15.

Further supplementation: the first mounting hole 16, the second cutting slit 19 and the first fixing hole 20 are used for clamping the sensor group 5; the second mounting hole 17, the first cutting slit 18 and the second fixing hole 21 are used for clamping the uniaxial loading head 1; the first cutting slit 18 and the second cutting slit 19 extend from the edge of one side of the clamping plate 2 to the second mounting hole 17 and the first mounting hole 16 respectively; the axes of the first fixing hole 20 and the second fixing hole 21 are perpendicular to and penetrate the second cutting slit 19 and the first cutting slit 18 respectively.

A working principle of the present disclosure is as follows: a prefabricated single-particle model is placed on the bearing platform 4. A small amount of epoxy resin is applied to the bottom of the single-particle model to bond the bottom of the single-particle model to the bearing platform 4. After the epoxy resin hardens, the uniaxial loading head 1 is lowered so that the needle body 8 touches the single-particle model and undergoes different degrees of displacements. Then, the push-pull handle 22 is pushed to fix the needle bodies 8 using the retainer 7. Subsequently, the uniaxial loading head 1 is raised again under the condition of maintaining the displacement of the needle bodies 8.

At this point, the needle bodies 8 on the full-coverage loading head 3 undergo different degrees of displacement due to the surface shapes of the single particles. The current displacement state is maintained by using the retainer 7 to lower the uniaxial loading head 1 for implementing full-coverage loading on the single-particle model until the single-particle model is damaged. A loading displacement is calculated through the sensor group 5. A loading force magnitude of the uniaxial loading head 1 is recorded, a single-particle stress-strain curve under full-coverage loading conditions is drawn, and the damage mode of the single-particle model is observed.

Some demonstrative implementations of the present disclosure are described above only through the mode of explanation. Undoubtedly, the described implementations can be corrected in various modes by those ordinary skilled in the art without departing from the spirit and the scope of the present disclosure. Therefore, the above drawings and illustration are explanatory in nature and should not be interpreted as a limitation to the protection scope of the claims of the present disclosure.

What is claimed is:

1. A single-particle full-coverage loading device, comprising a uniaxial loading head (1), a clamping plate (2), a bearing platform (4), a full-coverage loading head (3), and a sensor group (5), wherein one side of a top of the clamping plate (2) is provided with a first mounting hole (16), and the other side of the top of the clamping plate (2) is provided with a second mounting hole (17); and
the full-coverage loading head (3) further comprises a shell (6), a retainer (7) disposed in an inner cavity of the shell (6), needle chambers (9) disposed in the inner cavity of the shell (6), needle bodies (8) disposed in inner cavities of the needle chambers (9), spiral support rods (13) fixedly connected to one end of the needle bodies (8), springs (14) fixedly connected to one end of the spiral support rods (13), anti-shake column slits (10) provided at inner walls on both sides of the needle chambers (9), anti-shake columns (12) disposed in inner cavities of the anti-shake column slits (10), needle heads (11) fixedly connected to one end of the anti-shake columns (12), and a retaining slit provided at a lower part of the shell (6).

2. The single-particle full-coverage loading device according to claim 1, wherein the other end of the spring (14) is fixedly connected to a bottom of the inner cavity of the needle chamber (9), and the uniaxial loading head (1) is disposed in an inner cavity of the second mounting hole (17).

3. The single-particle full-coverage loading device according to claim 1, wherein one side of the clamping plate (2) is provided with a first cutting slit (18), and the other side of the clamping plate (2) is provided with a second cutting slit (19).

4. The single-particle full-coverage loading device according to claim 1, wherein one side of a front surface of the clamping plate (2) is provided with a first fixing hole (20), and the other side of the front surface of the clamping plate (2) is provided with a second fixing hole (21).

5. The single-particle full-coverage loading device according to claim 1, wherein one end of the retainer (7) is provided with a push-pull handle (22), and a surface of the retainer (7) is provided with triangular beams (15).
